(19) United States
(12) Patent Application Publication
(10) Pub. No.: US 2006/0045259 A1
(43) Pub. Date: Mar. 2, 2006

(54) Data entry pad and an electronic apparatus incorporating it

(76) Inventor: Franck Vizier, Louplande (FR)

Correspondence Address: Corporate Patent Counsel;Philips Electronics North America Corporation, P O Box 3001, Briarcliff Manor, NY, 10510, US

(21) Appl. No.: 10/492,449

(22) PCT Filed: Oct. 18, 2002
(86) PCT No.: PCT/IB02/04303

§ 371 Date: Jun. 16, 2005

(30) Foreign Application Priority Data
Oct. 16, 2001 (FR) 01/13331

(51) Int. Cl. H04M 1/00; H04M 9/00

(52) U.S. Cl. 379/433.04; 379/433.07

(57) ABSTRACT

The invention proposes a data entry unit (70), characterized in that it comprises a double-faced touch panel (48), the first upper face (46) of which is controlled by a first control device (26), such as a keypad, and the second lower face (62) of which is controlled by a second control device.

The invention also proposes an electronic apparatus, such as a mobile telephone, which includes such a data entry unit (70).

The invention proposes a data entry pad.

The invention also proposes an electronic apparatus which includes a casing on which a flap, which includes a data entry pad, is movably mounted.

Electronic apparatus has a tendency to be more and more miniaturized and the number of functions to be performed increases incessantly. On the other hand, users require the apparatus to be user-friendly and easy to use. For this purpose, it is advantageous to offer a display screen whose surface is as large as possible, and a device controlling all the functions which is easy to use and which allows rapid access to all the functions.

It is easy to understand that the search for miniaturization and the need to offer apparatus having numerous functions which are easy to use are two contradictory objectives with opposite consequences.

In addition, the number of functions to be fulfilled is increasing incessantly. Thus it is necessary to control all the functions in a minimum amount of space.

So as to propose a compromise between miniaturization and ease of use of a large number of functions, several solutions are already known.

For example, when the function control device consists of keys, also referred to as push buttons, it is possible to associate several functions with each of the keys. The selection of the function effected by actuating the keys may then, for example, be effected by another key or by a voice recognition device. However, such a solution runs counter to the user-friendliness and the ease of use of the apparatus. This is because a number of actuations on one or more keys may be necessary to perform the functions.

Another solution may consist of increasing the number of keys in the same space. However, the miniaturization of the keys is limited by the minimum size of the actuation area.

For other apparatus which have a display screen, it is possible to use part of this screen as a device for controlling certain functions. Such a screen is known as a touch screen.

However, the use of part of this screen as a control device reduces the surface area of the information display area accordingly. Consequently this reduces the user-friendliness of the apparatus. In addition, it is necessary to provide a device for selecting the screen function mode.

So as to afford a solution to these problems, the invention proposes a data entry keypad, characterized in that it has a double-faced touch panel whose first top face is controlled by a first control device, such as a keypad, and whose second bottom face is controlled by a second control device.

According to another characteristic, the entry keypad has means of discriminating the control mode by the first or second control device.

The invention also proposes an electronic apparatus which has a casing on which a flap is mounted so as to be able to move between a folded position in which a lower wall of the flap forming a bottom extends against an upper face of the casing, and an open position, of the type in which the flap of a first control device is able to cooperate with a first control device for a first control circuit of the apparatus, characterized in that the flap includes a data entry pad, of the type described above, forming the first control device when the flap is in the folded position and the first control device is cooperating with the first upper face of the touch pad, and forming a second control device for a second control circuit of the apparatus when the flap is in open position and the second control device is cooperating with the second lower face.

According to other characteristics of the invention:

the first control device is a keypad able to move between an idle position and an actuation position, having an upper control part and a lower actuation part which is able to cooperate with the upper face of the touch panel;

the touch panel is fixed to the lower face of the bottom wall, forming a support element for the first upper face of the touch panel when the flap is in open position, in which orifices associated with each key are produced so as to allow the lower actuation part of the keys to pass towards the first upper face of the touch panel, when the flap is in folded position;

elastic return elements are interposed between the upper face of the bottom wall and the keys so as to return the keys to the idle position;

the flap is articulated on the casing;

the flap is mounted so as to slide in translation on the casing;

the electronic apparatus is a mobile telephone of the GSM type.

The invention will be further described with reference to examples of embodiment shown in the drawings to which, however, the invention is not restricted.

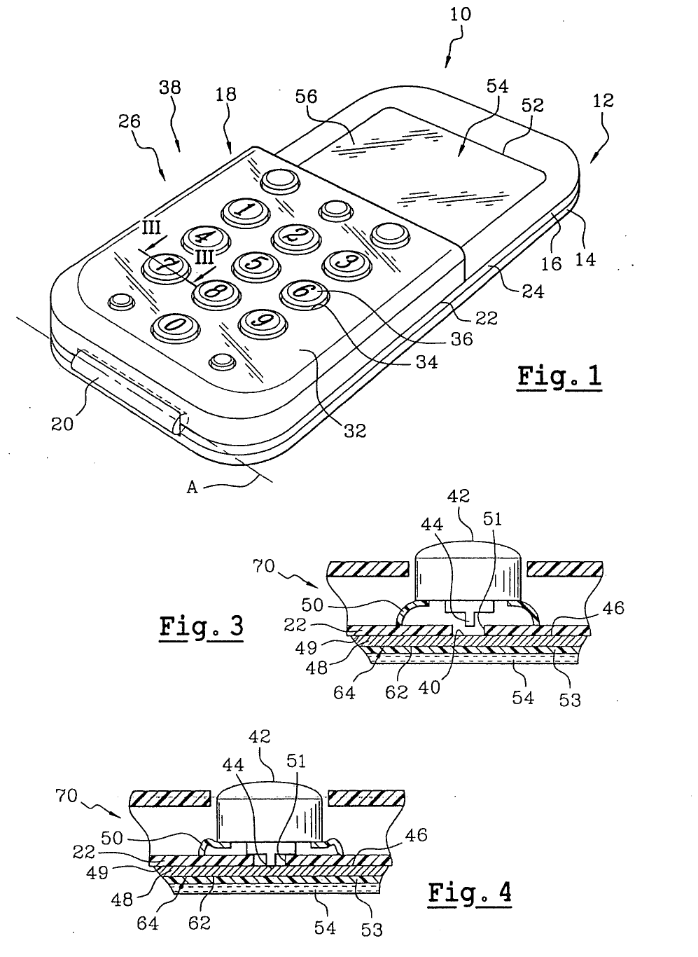

FIG. 1 is a schematic perspective view of a mobile telephone, for example of the GSM type, which consists of a casing and an articulated movable flap which has a data entry pad and which is shown here in folded position;

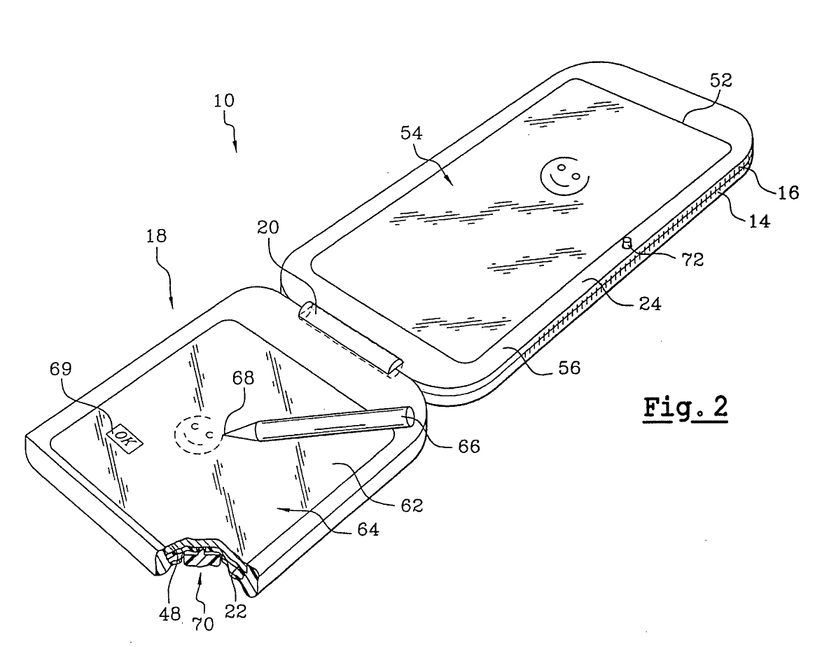

FIG. 2 is a schematic perspective view of the mobile telephone whose rotationally movable flap on the casing is shown in open position;

FIG. 3 is a schematic view in partial section, to a large scale, along the line III-III shown in FIG. 1, of a key on the data entry pad according to the invention illustrated in the idle position;

FIG. 4 is a view similar to that of the previous Figure, the key being shown in the actuation position; and

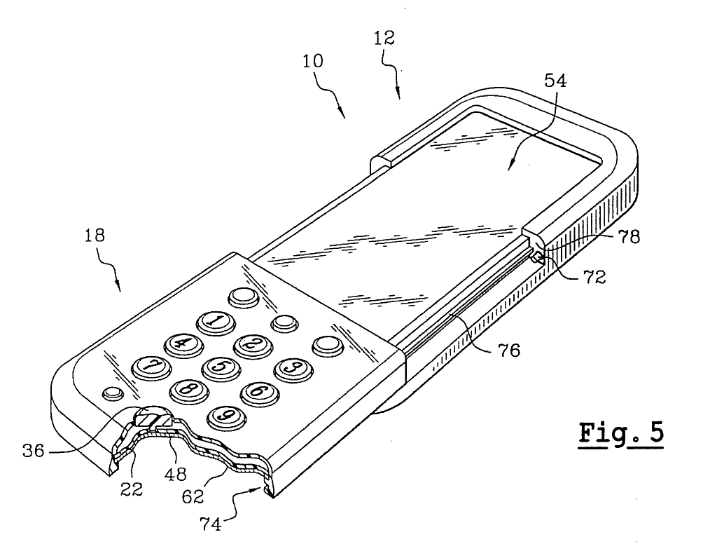

FIG. 5 is a schematic perspective view of the mobile telephone whose flap is mounted in translation on the casing and is shown in open position.

FIG. 1 depicts an electronic apparatus 10 which is here a mobile telephone which may for example be of the GSM type.

The telephone 10 has a casing 12 consisting of an upper shell 16 and a lower shell 14.

A flap 18 is movably mounted on the casing 12. It is here mounted so as to be articulated about an axis A of articulation 20 which can be produced partially in one piece with the flap, for example by molding.

The flap 18 is mounted so as to be able to move between a folded position, shown in FIG. 1, in which a lower wall 22 of the flap 18 forming a bottom lies against an upper face 24 of the casing 12, and an open position, depicted in FIG. 2, after a pivoting through 180° about the axis A.

The flap 18 has a first control device 16 which consists here unrestrictedly of a keypad.

For this purpose, an upper wall 32 of the flap 18 has orifices 34 which allow in particular the passage of the keys 36, which are here distributed in three horizontal series of three keys each and a tenth key situated in a central area under the bottom series forming a standard numeric keypad 38 with ten keys on the telephone 10.

The top faces of the keys 36 in the three horizontal series of the standard alphanumeric keypad 38 bear the figures 1 to 9. The top of the tenth bottom central key bears the figure 0.

In a known manner, the telephone 10 has other additional keys arranged around the standard numeric keypad 38.

The keys 36 are able to move vertically between a top idle position, shown in FIG. 6, and a bottom or pushed-in actuated position, shown in FIG. 4, in which each cooperates with a first control member 40 of an electric switch associated with the control of the first control circuit of the apparatus (not shown).

The keys 36 consist mainly of a top control part 42 on which a finger of the user can exert a control force. The part 42 forms the top of the corresponding key.

The keys 36 also consist of a rigid bottom actuation part 44 which is able to cooperate with the first control member 40.

The rigid bottom actuation part 44 is produced in the form of a central stem which extends vertically from the bottom face of the top of the upper part 42 of the corresponding key 36, as far as the top wall of the first associated control member 40.

In accordance with the invention, the first control member 40 is here the first upper face 46 of a double-faced touch panel 48. It is electrically connected to electrical conductors (not shown) for controlling the first control circuit of the apparatus.

By way of example, the double-faced touch panel 48 can be of the resistive type. In this case, it consists of an array of resistors, some of which are electrically interconnected so as to provide a first predetermined electrical signal when the flap 18 is in the folded position and so that the first control device 46 cooperates with a first predetermined area of the first upper face 46.

According to variants, the touch panel 48 can also be of the inductive or capacitive type.

The first electrical signal supplied then controls the first control circuit of the apparatus.

The double-faced touch panel 48 is here fixed against the lower surface 49 of the bottom wall 22 of the flap 18. So as to allow the passage of the rigid lower actuation part 44 of each key through the bottom wall 22, it has orifices 51.

The keys 36 are elastically returned to the idle position by elements 50 which consist here of elastically deformable domes which are interposed between the bottom wall 22 of the flap 18 and the keys so as in particular to return them to the idle position.

The upper shell 16 of the casing 12 of the electronic apparatus 10 also has a window 52 which has passing through it a display device or screen 54, such as a liquid crystal display screen, which is here substantially rectangular.

The actuation of the keys 36 of the standard keypad 38 makes it possible, by means of the first control member 40, for example to key in a combination of alphanumeric characters, in particular a telephone number, and to display it on the screen 54.

The actuation of another key on the keypad 38 can also make it possible to offhook or to validate a selection or an operation performed previously.

When the flap 18 is in the folded position in accordance with FIG. 1, the touch panel 48 is opposite a protection element 53 for the screen 54. Thus, when a key 36 is actuated, the touch panel 48 can deform downwards and come into abutment on the protective element 53, so as to limit its internal stresses.

In folded position, a first part 56 of the display screen 54 is visible, and its dimensions enable it to display in particular alphanumeric characters such as names and telephone numbers.

Thus, when the user wishes to make a telephone call, he uses the apparatus 10, the flap 18 being in folded position.

However, the apparatus 10 can have other operating modes such as an electronic diary, a memory aid, or an Internet access interface.

In this case, the dimensions of the first part 56 of the screen 54 may be too small to present sufficient information.

In addition, the control of certain functions, such as the rapid selection of a given day when the apparatus 10 is functioning in electronic diary mode or entering a text when it is functioning in memory aid mode, may be complicated to perform simply with the keys 36 of the standard keypad 38.

So as to increase the visible surface of the display screen 54, the flap 18 is pivoted about the axis A, so that it is arranged in open position, in accordance with FIG. 2. Thus the user can display the whole surface of the screen 54, which extends here over almost the complete upper wall 24 of the upper shell 16.

The large surface of the screen 54 thus makes it possible to display a large number of items of information such as alphanumeric characters or pictograms. This improves the ease of use of the screen 54 and the user friendliness of the apparatus 10. This is because the screen 54 can for example present the content of a web page or a weekly program. The quantity of information which can be displayed at a single glance by the user is large.

In open position, the lower wall 22 of the flap 18 is oriented towards the user.

In accordance with the configuration proposed, the second lower face 62 of the double-faced touch panel 48 is then oriented towards the user. According to the invention, the touch panel 48 then constitutes a second control member 64 for a second circuit (not shown) for controlling the apparatus.

The second control member 64 is controlled by a second control device 66 which may be a pencil, in accordance with FIG. 2, which cooperates with the second lower face 62.

According to a variant the second control device 66 can be the finger of the user or any other accessory able to control the second control member 64.

Contact of the point 68 of the pencil on the lower face 62 of the double-faced touch panel 48 controls the second control circuit of the apparatus by means of the second member 64.

This is because, referring to the example cited previously, in which the double-faced touch panel 48 consists of an array of resistors, the touch panel 48 supplies a second predetermined electrical signal when the flap 18 is in open position and when the second control device 66 cooperates with a second predetermined area of the second lower face 62.

The second electrical signal supplied then controls the second control circuit of the apparatus.

It should be noted that, when the first predetermined area of the upper face 46 is opposite the second predetermined area of the lower face 62, the predetermined electrical signal supplied is the same when the flap 18 is in folded position and the first device 26 controls the first predetermined area, as when the flap 18 is in open position and the second device 66 controls the second predetermined area.

Thus the flap 18 has a data entry pad 70 consisting of the double-faced touch panel 48 whose first upper face 46 is controlled by the first control device 26, and which is here in particular the standard keypad 38, and the second lower face 62 of which is controlled by the second control device 66, which is a pencil here.

The data entry pad 70 can also allow the user to browse through the telephone menus 10.

The entry keypad 70 is connected by conductive electrical elements (not shown) to the first and second control circuit of the apparatus.

The double-faced touch panel 48 is here in contact with the bottom 22 of the flap 18, which makes it possible in particular to limit the size of the flap 18.

According to a variant, the double-faced touch panel 48 can be slightly offset so as not to touch the lower surface 49 of the bottom 22. In this case, the panel 48 must be sufficiently rigid to limit its deformations when the second control device 66 cooperates with the lower face 62.

The bottom 22 of the flap 18 can form a support element for the first upper face 46 of the double-faced touch panel 48.

Thus, when the second control device 66 comes into contact with the second lower face 62, the double-faced touch panel 48 can deform upwards and come into abutment on the bottom 22, so as to limit its deformations and its internal stresses.

In this case, the diameter of the orifices 51, which allows the passage of the rigid lower actuation part 44 of the keys, must be as small as possible in order to limit the areas of the panel 48 which cannot bear against the bottom 22. In practice the diameter of the orifices is advantageously less than 3 mm.

Advantageously, a layer of insulating material is interposed between the first upper face 46 of the touch panel 48 and the lower surface 49 of the bottom 22, so as to prevent risks of unwanted electrical connection of the resistors on the panel 48 when it is in contact with the bottom 22.

Advantageously, the touch panel 48 can be designed sufficiently rigidly so as not to deform when it is acted on by the control devices 26, 66. In this case, it may form the bottom of the flap 18, the lower wall 26 then being able to be omitted.

The invention thus makes it possible to propose a telephone 10 whose screen has a large surface area.

In addition, the second lower face 62 of the touch panel 48 here makes it possible to increase the possibilities of controlling the telephone 10 compared with control by a keypad. This is because the second control member 64 offers the possibility of drawing. FIG. 2 depicts in broken lines, on the lower face 62 of the panel 48, the path which the point 68 of the pencil has traveled in contact with the lower face 62 of the panel 48; the path is displayed on the screen 54.

Thus the user can draw diagrams, which he can then send to a correspondent.

The contact of the point 68 with some areas 69 may make it possible to control predetermined functions such as the validation of a command.

The area 69 can be determined by a representation printed on the second lower face 62. It may also, when the lower face 62 of the panel 48 is of the “touch screen” type, appear or not depending on the position of the user in the menu of the telephone 10.

For the purpose of determining the active control mode of the double-faced touch panel 48, that is to say whether the panel 48 makes it possible to control the first or second control circuit of the telephone 10, the entry keypad 70 has discrimination means.

The discrimination means may consist of a switch which is connected to a push button 72 able to move between a pressed-in position and an out position, in accordance with the representation in FIG. 2.

Thus, when the flap 18 is in the folded position, it presses in the button 72, and the touch panel 48 then functions according to the first command mode.

When the flap 18 is in open position, the button 72 is out, and the touch screen 48 then functions according to the second control mode.

According to a variant, the discrimination means can consist of a key of the telephone 10, each pressure on the key switching from the first control mode to the second, and vice-versa.

The above description is not limiting. This is because, according to a variant shown in FIG. 5, the flap 18 can be mounted so as to slide in translation on the casing 18. It is guided longitudinally by grooves 74 which cooperate with complementary guide rails 76 on the casing 12. There are discrimination means again, whose button 72 is arranged longitudinally in a transverse abutment face 78 of the flap 18 when it is in the folded position.

In this configuration, the lower face 62 of the panel 48 is oriented in an opposite direction with respect to the display screen 54.

Consequently, it is necessary to turn over the telephone in order to use the second control member 68. Thus it is advantageous for the telephone to be equipped with a second screen (not shown) situated in the lower wall of the lower shell 14. The second screen is then activated in particular when the flap 18 is in open position.

1. A data entry unit (70), characterized in that it comprises a double-faced touch panel (48) whose first upper face (46) is controlled by a first control device (26), such as a keypad, and whose second lower face (62) is controlled by a second control device (66).

2. A data entry unit (70) as claimed in claim 1, characterized in that it has means of discriminating the mode of control by the first or second control device (26, 66).

3. An electronic apparatus (10) which comprises a casing (12) on which a flap (18) is mounted so as to be able to move between a folded position, in which a lower wall (22) of the flap (18) forming a bottom extends against an upper face (24) of the casing (12), and an open position of the type in which the flap (18) of a first control device (26) is able to cooperate with a first control member (40) of a first control circuit of the apparatus (10), characterized in that the flap (18) comprises a data entry unit (70) as claimed in claim 1, forming the first control member (40) when the flap (18) is in the folded position and when the first control device (26) cooperates with the first upper face (46) of the touch panel (48), and forming a second control member (64) of a second control circuit of the apparatus when the flap (18) is in open position and when the second control device (66) cooperates with the second lower face (62).

4. An electronic apparatus (10) as claimed in claim 1, characterized in that the first control device (26) is a keypad with keys (36) able to move between an idle position and an actuation position having an upper control part (42) and a lower actuation part (44) which is able to cooperate with the upper face (46) of the touch panel (48).

5. An electronic apparatus as claimed in claim 1, characterized in that the touch panel (48) is fixed against the lower surface (49) of the bottom wall (22), forming a support element for the first upper face (46) of the touch panel (48) when the flap (18) is in open position, in which orifices (51) are produced associated with each key (36) so as to enable the lower actuation parts (44) of the keys (36) to pass towards the first upper face (46) of the touch panel (48), when the flap (18) is in folded position.

6. An electronic apparatus as claimed in claim 1, characterized in that elastic return elements (50) are interposed between the upper face of the bottom wall (22) and the keys (36) so as to return the keys (36) to the idle position.

7. An electronic apparatus as claimed in claim 3, characterized in that the flap (18) is articulated on the casing (12).

8. An electronic apparatus as claimed in claim 2, characterized in that the flap (18) is mounted so as to slide in translation on the casing (12).

9. An electronic apparatus as claimed in claim 2, characterized in that it is a mobile telephone of the GSM type.
